(19) United States
(12) Patent Application Publication
(10) Pub. No.: US 2010/0214779 A1
(43) Pub. Date: Aug. 26, 2010

(54) LED Fluorescent Tube

(76) Inventor: Ying-Feng Kao, Taipei City (TW)

Correspondence Address: WPAT, PC;INTELLECTUAL PROPERTY ATTORNEYS, 7225 BEVERLY ST., ANNANDALE, VA, 22003, US

(21) Appl. No.: 12/390,958

(22) Filed: Feb. 23, 2009

(51) Int. Cl. F21V 21/00

(52) U.S. Cl. 362/249.02

(57) ABSTRACT

The invention discloses a LED fluorescent tube, having a plurality of LED modules, a linear tube and a converter. The plurality of LED modules are serially configured on one side of the linear tube, wherein each LED module comprises a PCB and a plurality of LEDs, serially configured on the PCB. The converter is configured within the linear tube for converting alternating current into direct current to supply power to the plurality of LED modules.

### BACKGROUND OF THE INVENTION

1. Field of the Invention

The present invention generally relates to a fluorescent tube, and more particularly to a LED fluorescent tube.

2. Description of the Prior Art

The fundamental means for conversion of electrical energy into radiant energy in a fluorescent lamp relies on inelastic scattering of electrons. An incident electron collides with an atom in the gas. If the free electron has enough kinetic energy, it transfers energy to the atom's outer electron, causing that electron to temporarily jump up to a higher energy level. This is why the collision is called ‘inelastic,’ as some of the energy is transferred.

This higher energy state is unstable, and the atom will emit an ultraviolet photon as the atom's electron reverts to a lower, more stable, energy level. Most of the photons that are released from the mercury atoms have wavelengths in the ultraviolet (UV) region of the spectrum predominantly at wavelengths of 253.7 nm and 185 nm. This is not visible to the human eye, so must be converted into visible light. This is done by making use of fluorescence. Ultraviolet photons are absorbed by electrons in the atoms of the lamp's fluorescent coating, causing a similar energy jump, then drop, with emission of a further photon. The photon that is emitted from this second interaction has a lower energy than the one that caused it. The chemicals that make up the phosphor are chosen so that these emitted photons are at wavelengths visible to the human eye. The difference in energy between the absorbed ultra-violet photon and the emitted visible light photon goes to heat up the phosphor coating.

The efficiency of fluorescent lighting owes much to the fact that low pressure mercury discharges emit about 65% of their total light in the 254 nm line (another 10-20% of the light is emitted in the 185 nm line). The UV light is absorbed by the bulb's fluorescent coating, which re-radiates the energy at longer wavelengths to emit visible light. The blend of phosphors controls the color of the light, and along with the bulb's glass prevents the harmful UV light from escaping.

When the light is turned on, the electric power heats up the cathode enough for it to emit electrons. These electrons collide with and ionize noble gas atoms in the bulb surrounding the filament to form a plasma by a process of impact ionization. As a result of avalanche ionization, the conductivity of the ionized gas rapidly rises, allowing higher currents to flow through the lamp.

However, the environment is always contaminated due to the fabrication of above-mentioned fluorescent tube. Thus, it is important to provide a new type of the fluorescent tube.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

The invention discloses a LED (Light Emitting Diode) fluorescent tube, comprising a plurality of LED modules, a linear tube and a converter.

The plurality of LED modules are serially configured on one side of the linear tube, wherein each LED module comprises a PCB (Printed Circuit Board) and a plurality of LEDs, and the plurality of LEDs are serially configured on the PCB.

The converter is configured within the linear tube for converting alternating current into direct current to supply power to the plurality of LED modules.

The LED fluorescent tube further comprises two solderless terminals, wherein two solderless terminals are separately configured with two ends of the LED fluorescent tube for plugging the LED fluorescent tube in two terminal blocks of a lamp holder.

In addition, the two solderless terminals could be displaced by two connecting jacks, and the LED fluorescent tube further comprises a power cord. Thus, the power of the LED fluorescent tube could be supplied from a power source through the power cord, wherein one end of the power cord is electrically connected with the power source, and the other end of the power cord is plugged in a connecting jack.

Besides, the LED fluorescent tube further comprises a conducting wire for series connecting to another LED fluorescent tube, wherein one end of the conducting wire is plugged in a connecting jack of one LED fluorescent tube, and the other end of the conducting wire is plugged in a connecting jack of another LED fluorescent tube.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIGS. 1A, 1B, 1C and 2B are diagrams illustrates the structure of the LED fluorescent tube;

FIG. 1D is a diagram depicts the applied structure of the LED fluorescent tube and the lamp holder; and

FIG. 2A is a diagram shows the series connection of the LED fluorescent tubes.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

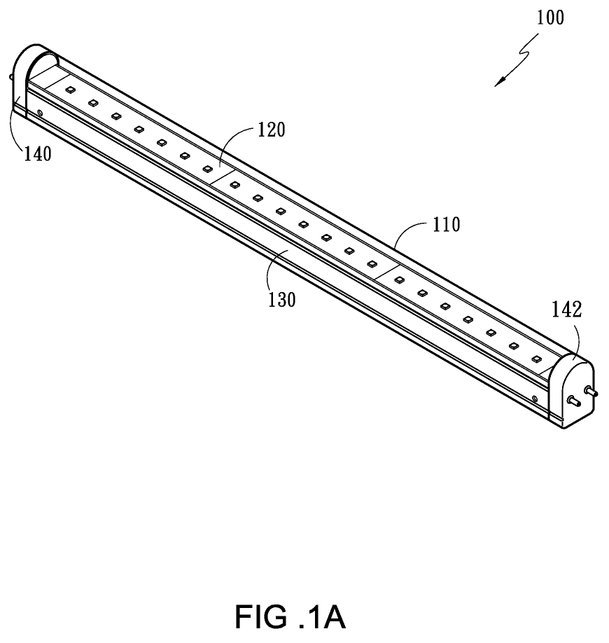

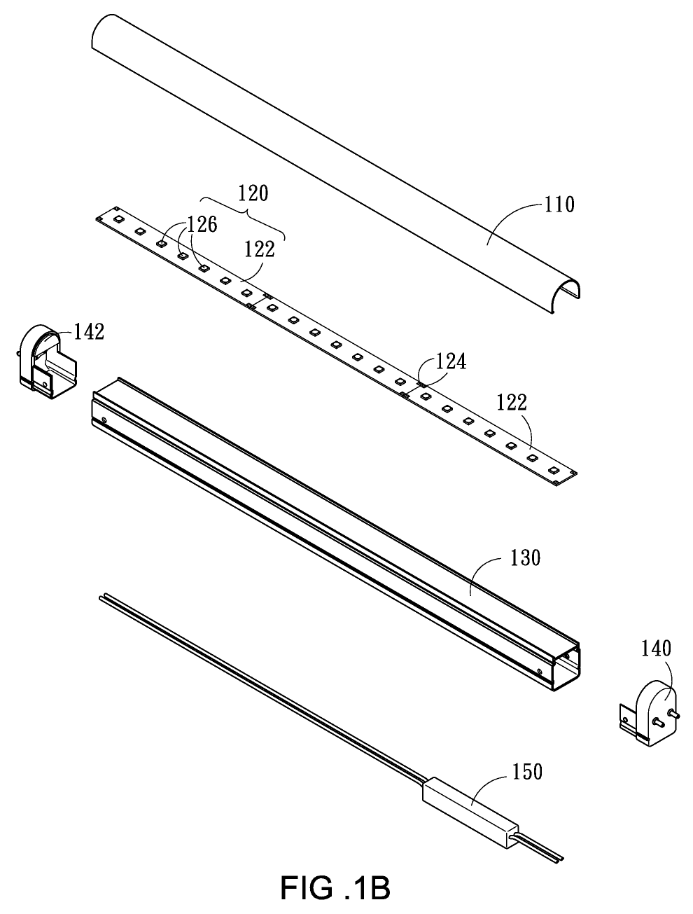

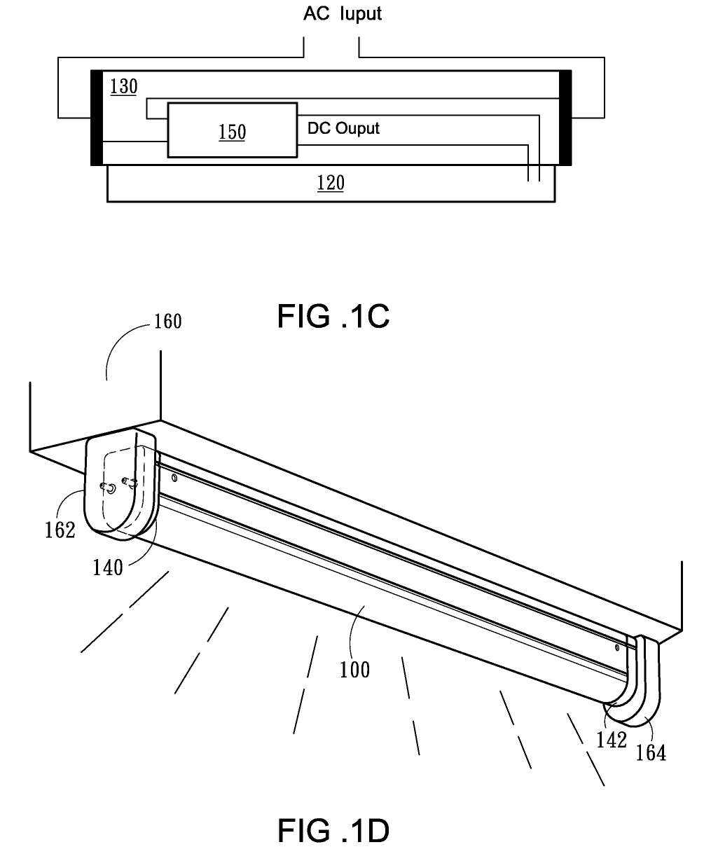

Referring to FIGS. 1A and 1B, a LED (Light Emitting Diode) fluorescent tube 100 is disclosed, wherein the LED fluorescent tube 100 comprises a plurality of LED modules 120, a linear tube 130 and a converter 150.

The plurality of LED modules 120 are serially configured on one side of the linear tube 130, wherein each LED module 120 comprises a PCB (Printed Circuit Board) 122 and a plurality of LEDs 126, and the plurality of LEDs 126 are serially configured on the PCB 122.

Referring to FIGS. 1A, 1B and 1C, the converter 150 is configured within the linear tube 130 for converting alternating current into direct current to supply power to the plurality of LED modules 120.

Referring to FIG. 1B, the plurality of PCBs 120 could be connected in series by welding, or buckled in series by conducting elements. In addition, the LED fluorescent tube 100 further comprises a curve lampshade 110 for covering the plurality of LED modules 120.

Referring to FIG. 1D, the LED fluorescent tube 100 further comprises two solderless terminals 140, 144, wherein two solderless terminals 140, 144 are separately configured with two ends of the LED fluorescent tube 100 for plugging the LED fluorescent tube 100 in two terminal blocks 162, 164 of a lamp holder 160.

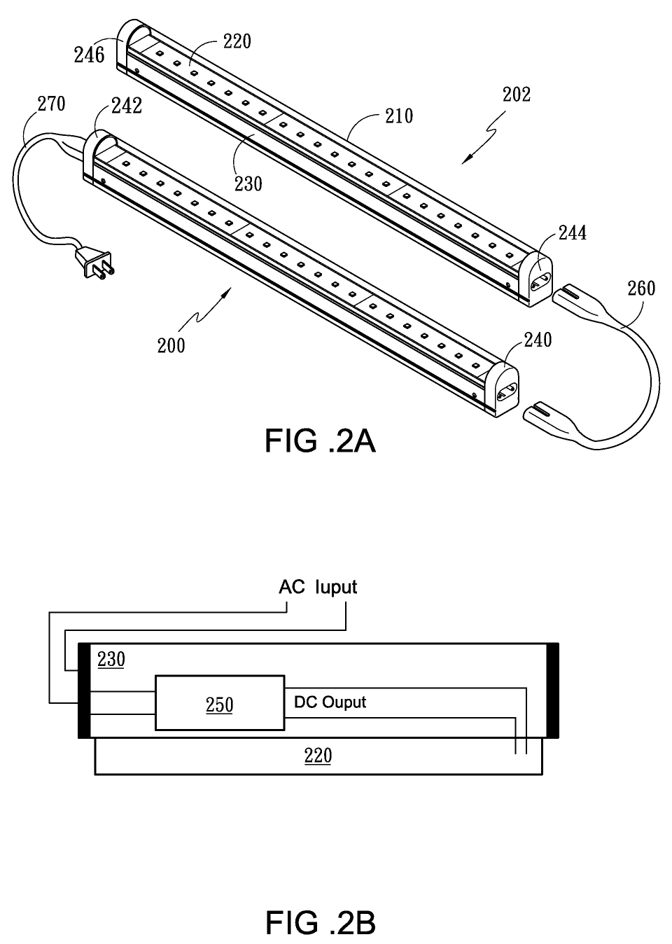

Referring to FIG. 2A, another type of the LED fluorescent tube 200 is disclosed, wherein the plurality of LED modules 220 are serially configured on one side of the linear tube, and the plurality of LED modules 220 are covered by the curve lampshade 210.

The LED fluorescent tube 200 further comprises two connecting jacks, separately configured with two ends of the LED fluorescent tube 200, and the power of the LED fluorescent tube 200 is supplied from a power source through a power cord 270, wherein one end of the power cord 270 is electrically connected with the power source, and the other end of the power cord 270 is plugged in the connecting jack 242. Besides, the LED fluorescent tube 200 could be series connected to another LED fluorescent tube 202 by a conducting wire 260, wherein one end of the conducting wire 260 is plugged in the connecting jack 240 of one LED fluorescent tube 200, and the other end of the conducting wire 260 is plugged in the connecting jack 244 of another LED fluorescent tube 202.

Referring to FIG. 2B, the converter 250 could be configured within the linear tube 230 for converting alternating current into direct current for supplying power to the plurality of LED modules 220.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A LED (Light Emitting Diode) fluorescent tube, comprising:
a linear tube;
a plurality of LED modules, serially configured on one side of said linear tube, wherein each LED module comprises a PCB (Printed Circuit Board) and a plurality of LEDs, serially configured on said PCB; and
a converter, configured within said linear tube for converting alternating current into direct current to supply power to said plurality of LED modules.

2. A LED fluorescent tube of claim 1, wherein said plurality of PCBs are connected in series by welding.

3. A LED fluorescent tube of claim 1, wherein said plurality of PCBs are connected in series by conducting elements.

4. A LED fluorescent tube of claim 1, further comprising a curve lampshade for covering said plurality of LED modules.

5. A LED fluorescent tube of claim 1, further comprising two solderless terminals, separately configured with two ends of said LED fluorescent tube for plugging said LED fluorescent tube in two terminal blocks of a lamp holder.

6. A LED fluorescent tube of claim 1, further comprising two connecting jacks, separately configured with two ends of said LED fluorescent tube.

7. A LED fluorescent tube of claim 6, further comprising a power cord with a connecting jack and a power source connected.

8. A LED fluorescent tube of claim 6, further comprising a conducting wire, wherein one end of said conducting wire is plugged in a connecting jack of one LED fluorescent tube, and the other end of said conducting wire is plugged in a connecting jack of another LED fluorescent tube for series connection of said two LED fluorescent tubes.
